(19) United States
(12) Patent Application Publication
(10) Pub. No.: US 2005/0273811 A1
(43) Pub. Date: Dec. 8, 2005

(54) Method and system of integrated sole-source television and direct mail advertising

(76) Inventors: Joseph A. Koff, Baltimore, MD (US); David Deniston Smith, Lutherville, MD (US); Darren Jay Shapiro, Owings Mills, MD (US); Jeffrey Sleete, Phoenix, MD (US)

Correspondence Address: Law Offices of Royal W. Craig, Suite 153, 10 N. Calvert Street, Baltimore, MD, 21202, US

(21) Appl. No.: 11/126,593

(22) Filed: May 11, 2005

Related U.S. Application Data
(60) Provisional application No. 60/570,617, filed on May 12, 2004.

(51) Int. Cl. H04N 7/025; H04N 7/173; H04N 7/10

(52) U.S. Cl. 725/35; 725/34; 725/32

(57) ABSTRACT

A method and system of integrated television and direct mail advertising with a value-added pricing approach, which integrates television advertising with direct mail from a sole source broadcaster. The broadcaster markets television air-time to direct-mail advertisers and adds a value-added direct mail incentive at no cost to transition them into new-media advertising. The direct mail component comprises a monthly circular with cross-media tactics, such as contests, promotions, coupons, and other incentives, which are cross-referenced between the dual media advertisements. The cross-referencing of the direct mail circular in television advertising, and vice versa, makes the dual-media advertising truly integrated in its approach.

### CROSS REFERENCE TO RELATED APPLICATIONS

The present application derives priority from U.S. Provisional Patent Application 60/570,617 filed May 11, 2004.

### BACKGROUND OF THE INVENTION

1. Field of the invention

The present invention relates to cross-media advertising, and more specifically, to a method and system for integrated sole-source television and direct mail advertising.

2. Description of the Background

There are numerous existing vehicles and strategies for marketing goods and services to the consuming public. Mass media advertising is one of the most common and beneficial approaches and includes cable and network television air time, radio, the Internet, and print publications. Other common and effective forms of advertising include signage, direct mail, contests, and special promotions.

Many purchasers of advertising buy different forms of advertising in an attempt to reach a cross-section of the consuming public. For example, a buyer may purchase a television advertising schedule, signage, and magazine advertisements, while another buyer may purchase a television schedule, signage, Internet, and direct mail. The need to advertise across media has grown as the modes of reaching the public have grown. Internet advertising is a good example of a medium that was practically non-existent several years ago, but has become a multi-billion dollar business.

Direct mail is a successful mode of local advertising because it is generally cost-effective and can reach a large number of households, introducing new customers and generating increased sales. Direct mail advertising publications generally include a combination of coupons, contests, promotions, give-aways, and other incentives.

Over the air commercial television earns revenue by advertising. The market generally drives the amount of advertising time because consumers prefer programming and won't accept too much advertising if it interferes with programming. Rather than airing more commercials, television stations may try to increase revenue by increasing prices. However, the price one is willing to pay for advertising is also market driven.

Due to the advantages and disadvantages in different advertising media, advertisers may elect to promote their goods and services by using multiple forms or cross-media advertising. Methods for cross-media advertising are well demonstrated in the prior art. For example, U.S. patent application No. 20030080999 by Stone et al. filed May 1, 2003, shows a method of using a network of computers to facilitate and control the publishing of presentations to a plurality of print media venues. The software includes an automated media presentation generator with a publication and ad placement control engine that integrates ad placements cross-media.

U.S. patent application 20030229536 by House et al. filed Dec. 11, 2003 shows a media planning and buying system and method for planning and executing a marketing communications campaign using a computer-implemented system. The system provides the advantages typically available only to larger purchasers without having to maintain the advertising budgets of such large purchasers. The system allows the user to input preferences about the media/communications campaign into interactive worksheets. The preferences are used to produce prototype plans which present a week-by-week schedule of media purchasing as well as an allocation to various media/communications classifications. Once a plan is approved, the system facilitates media purchases with strategic media/communications providers at discounted rates. This system provides the small purchasers with all the buying clout of a large purchaser, provides expertise to those who may lack it, and significantly reduces the time and costs currently required for media planning and buying.

U.S. patent application 20020032603 by Yeiser, John O. filed Mar. 14, 2002 shows a method for promoting internet web sites by purchasing a block of air time from a media provider such as a television channel or web provider, producing a media segment displaying a scrolling list of web site addresses, graphical banners and video clips of a host who talks about a featured service, product or web site. A web site proprietor may select any one or combination of several advertising options. Additional interest in a client's web site is generated by providing a video which is produced and maintained by the advertising service provider and providing a hyperlink at the client's web site for accessing and playing the video.

U.S. patent application 20030220866 by Pisaris-Henderson et al filed Nov. 27, 2003 shows a system and method for pay-for-perform and advertising in general media. A service provider defines at least one biddable advertisement for presentation in advertising media, and an open auction is conducted by the service provider.

U.S. patent application 20030171096 by Ilan et al. filed Sep. 11, 2003 shows a system and method for distributing coupons through broadcast media such as television and radio, displays, such as signage, etc., or passively, through displays such as signage or the like.

There are other prior art references that address cross-media advertising. For example, a publication, the “Cross-Media Partnerships Grow” article (June 2003), suggests that a growing group of newspapers and TV and radio stations are forming alliances that will help them sell cross-media advertising and cross-promotion.

Despite these alliances, no known broadcasters have taken it upon themselves to market an integrated package using television advertising to deploy a primary message, with a value-added direct mail component.

It would be greatly advantageous to provide a method and system of integrated sole-source television and direct mail advertising with a value-added pricing approach. The present method integrates television advertising with direct mail from a sole source broadcaster. The broadcaster markets television airtime to direct-mail advertisers and adds a value-added direct mail incentive at no cost to transition them into new-media advertising. The direct mail component comprises a monthly circular with cross-media tactics, such as contests, promotions, coupons, and other incentives, which are cross-referenced between the dual media advertisements. The cross-referencing of the direct mail circular in television advertising, and vice versa, makes the dual-media advertising truly integrated in its approach.

### SUMMARY OF THE INVENTION

It is therefore an object of the present invention to provide a method of integrated television advertising with a value-added direct mail component that appeals to business advertisers.

It is a further object of the present invention to provide a method of integrated sole-source television and direct mail advertising that allows a business advertiser to retain the familiar and comfortable benefits of print media advertising, with a price incentive to try and transition into television advertising.

It is a still further object of the present invention to provide a method and system of integrated sole-source television and direct mail advertising as described above that cross-references the dual media, with incentives, such as promotions and contests.

It is yet another object of the invention to provide a method of integrated sole-source television and direct mail advertising that delivers a primary message to consumers, and adds an alternative component at no additional perceived cost to the advertiser which allows them to tell consumers that they gave them the primary message, thereby reaching a maximum number of consumers.

It is still another object of the invention to provide a method and system of integrated sole-source television and direct mail advertising as described above that is cost-effective.

The present method appeals to the small business owner who has generally used the print media approach to advertising and shied away from television advertising. It gives the advertiser a monetary incentive by including the comfortable direct mailer at no cost, while transitioning the advertiser to television advertising.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a block diagram of the integrated television and direct mail advertising method according to the present invention.

FIG. 2 is a detailed flow diagram of the method of integrated sole-source television and direct mail advertising as in FIG. 1.

FIG. 3 is a page from an exemplary direct mailer showing the cross-reference to television.

### DETAILED DESCRIPTION OF THE PREFERRED EMBODIMENTS

Television advertising reaches more consumers than any other medium, yet many traditional print media advertisers have not tapped this mode of advertising. Many small businesses believe it is too expensive, while others shy away because of the fear of “broadcasting”, or the fear of “being on television”. The net result is that many businesses continue to advertise in print media only. The method of the present invention overcomes these perceptions by allowing the small business advertiser to retain the benefit of the familiar and comfortable print media that they are accustomed to, at no perceived cost, while trying (and eventually transitioning) into television advertising. Thus, business advertisers are able to reach new customers that they would not have reached by print advertising only. Direct mail is combined with the power of television for the most effective use of advertising dollars.

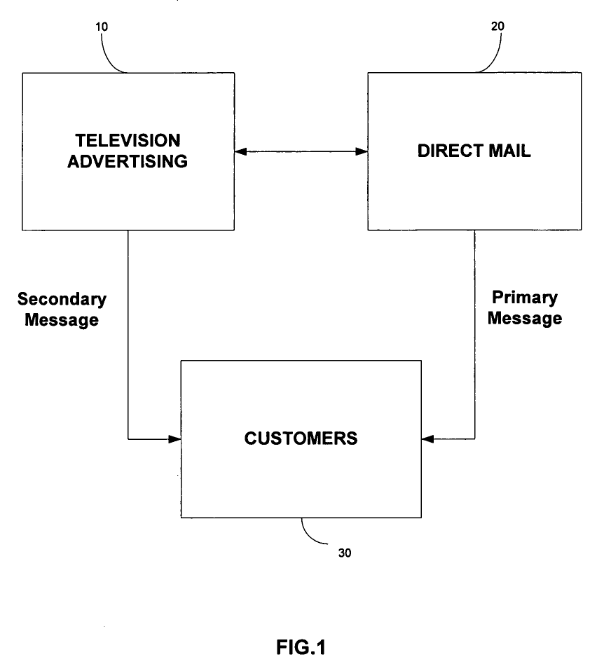

FIG. 1 is a block diagram of the integrated television and direct mail advertising method according to the present invention, by which a primary message is delivered to consumers by direct mail, and a broadcast component reinforces the primary message with a secondary message which allows the advertiser to tell consumers that they gave them the primary message (or that they soon will), thereby reaching a maximum number of consumers. In accordance with the method of the present invention, the broadcast component is marketed to the advertiser using traditional broadcast media pricing for air time, at a suggested level which results in a cost to the advertiser that is commensurate with their established direct mail campaign costs.

The direct mail component is included as a value added service (offered for sale at no perceived cost) to give the advertiser the confidence to try the integrated method without risk of losing any established direct mail client base. As described below, the broadcast component includes both standalone advertising as well as a cross-reference to the direct mail component to fortify exposure, thereby establishing an integrated method of sole-source television and direct mail advertising. Results may be tracked, and as the effectiveness of the standalone broadcast advertising becomes clear to the advertiser they have incentive to transition into the new-media broadcast advertising.

More specifically, at block 10 broadcast television advertising is aired to reach customers at block 30. This is followed by direct mail advertising at block 20 which is mailed to customers 30. Both the direct mail advertising at block 20 and television advertising 10 include content, as will be described, that cross-reference the other.

The direct mail advertising at block 20 is implemented using a direct mailer that promotes the television stations as well as the individual advertisers. The direct mailer is oversized (i.e., tabloid size) so it dominates the mailbox. While the direct mailer is mailed to a database of direct mail addresses, the content is geared toward a television audience. For example, the direct mailer includes recognizable television station call letters, and television personalities dominate the cover to grab the attention of the recipient. In addition to the television station content, the direct mailer includes standalone business advertisements placed by the advertising client. Cross-referencing is accomplished by a combination of insert messages and incentives. The insert messages prompt the reader to watch the sponsoring television station at the appropriate time to see the broadcast component advertising. The incentives to do so take the form of coupons, promotions, and contests that generally make the mailer more interesting to the consumer than a simple advertising circular, and which offer incentive to watch the sponsoring television station at the appropriate time to see the broadcast component advertising. For example, the direct mailer will advertise a contest that encourages the consumer to participate in the contest by watching the sponsor television station at a specified time, and to be the Nth caller to answer a trivia question and win a prize.

In a similar manner, the direct mailer is promoted on air via the broadcast component 10. For example, a television viewer is encouraged to look for the rules for a specific contest in the next mailer.

In the foregoing manner, the direct mailer complements the television advertisement and vice versa, presenting a cohesive and integrated marketing approach to the consuming public. The combined television and direct mail advertising provides the opportunity for a given businesses' print advertisement to reach more consumers more often thanks to the broadcast component, which extends the total reach of all advertising.

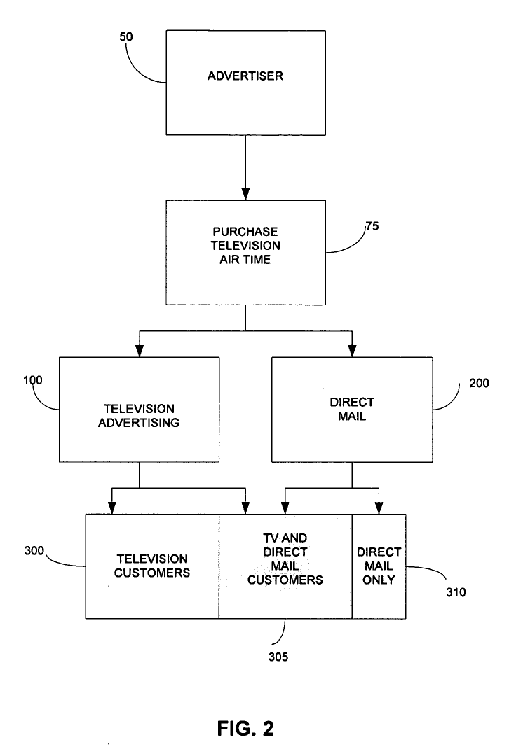

FIG. 2 is a more detailed flow diagram of the method of integrated sole-source television and direct mail advertising. At Step 50, a business determines that it has a need to advertise its goods or services. The present method is geared toward advertisers that have traditionally employed direct mail campaigns, and who have a resistance to trying a broadcast media approach. Consequently, the broadcast component is marketed to the advertiser using traditional broadcast media pricing for air time, but at a suggested level which results in a cost to the advertiser that is equivalent to that of their established direct mail campaign costs. The direct mail component is offered as a value added service (no perceived cost) to give the advertiser the incentive to try the integrated method.

Thus, at Step 75, the business advertiser decides to purchase a schedule of television air time to advertise its goods or services. For example, a schedule of air time may be three times per week for twenty-six weeks.

At Step 100, the television advertisement is produced and aired to the public. During the time period that the television advertisement is scheduled to be aired, the sponsoring broadcaster also promotes the television station and the direct mailer with a cross-reference to the mailer, which may take the form of scrolling text messages or narrative from television personalities. Specifically, the broadcaster may prompt the reader to “look for the forthcoming direct mail circular”, which is explained to contain coupons, promotions, and contests that generally make the message more compelling.

Subsequently, at Step 200, a print advertisement is created for the monthly direct mailer and the direct mailer is mailed to residents in the local television broadcast viewing area (typically by ZIP code). Consequently, the television advertising created at Step 100 will be received by television viewers 300 inclusive of a subset of direct mail recipients 305. Conversely, the direct mailer created at Step 200 is received by direct mail recipients 310 which includes a subset of television viewers 300. Thus, the integrated cross-media advertising method of the present invention reaches more total consumers than either medium alone, and provides reinforced cross-referenced advertising to a core subset of consumers.

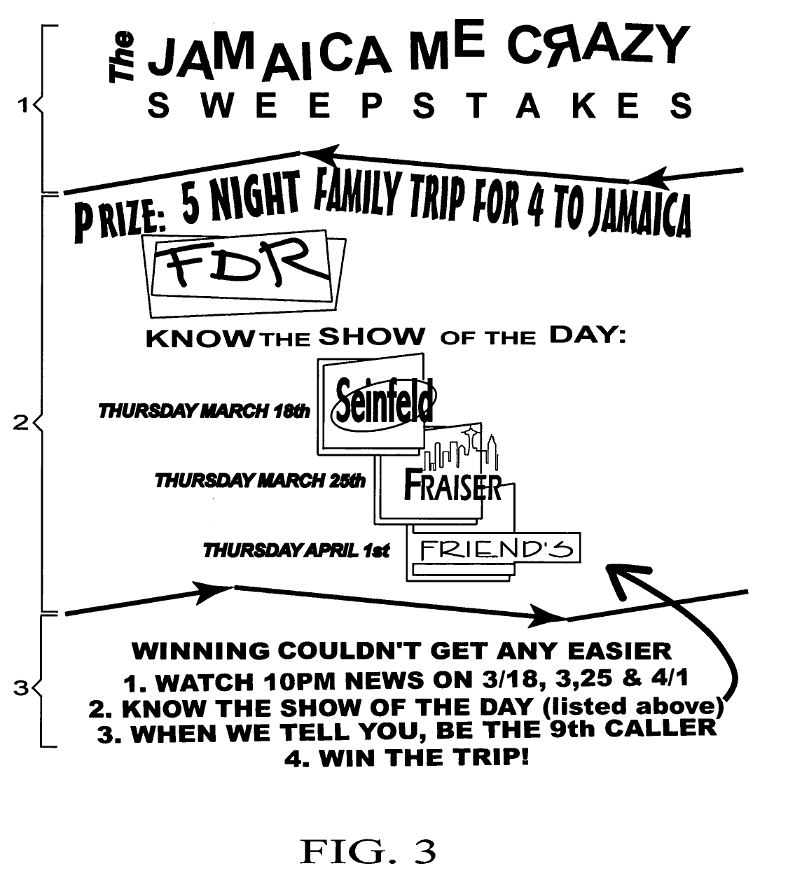

FIG. 3 is a page from an exemplary mailer that promotes the television station and introduces a television contest. The Banner section 1 announces the sweepstakes, the middle section 2 identifies how to win the contest, and the bottom section 3 provides the rules for the contest. The recipient of the mailer is encouraged to watch the television station and telephone the station with the contest answer, and if the caller is the nth caller, he or she will win the contest.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

1. A method for a sponsoring broadcaster to provide integrated television and direct mail advertising to an advertiser using a value-added pricing approach, comprising the steps of:
providing television advertising for said advertiser at a price comparable to direct mail, and framing said television advertising with a cross-reference message to look for a forthcoming direct mailer;
distributing a direct mailer for said advertiser to a local viewing area at no perceived cost to the advertiser, said direct mailer including cross-referencing to said television advertising;
whereby said television advertising is integrated with said direct mail advertising by said broadcaster.

2. The method and system of integrated television and direct mail advertising according to claim 1, wherein said direct mailer comprises a monthly circular with cross-media tactics of contests, promotions, coupons, which are cross-referenced between the dual media advertisements.

3. The method and system of integrated television and direct mail advertising according to claim 1, wherein said television advertising comprises standalone advertising and a cross-reference to the direct mail component.

4. The method and system of integrated television and direct mail advertising according to claim 1, wherein said direct mailer is tabloid size.

5. The method and system of integrated television and direct mail advertising according to claim 1, wherein the results of said television advertising and direct mail advertising are tracked.

6. The method and system of integrated television and direct mail advertising according to claim 1, wherein said direct mailer promotes the television stations and individual advertisers.

7. The method and system of integrated television and direct mail advertising according to claim 1, wherein said direct mailer includes television station call letters and television personality images on the cover.

8. The method and system of integrated television and direct mail advertising according to claim 1, wherein said direct mailer includes insert messages that prompt the reader to watch the sponsoring television station at a specific time to see the broadcast advertising component.

9. The method and system of integrated television and direct mail advertising according to claim 1, wherein said direct mailer includes coupons, promotions and contests.

10. The method and system of integrated television and direct mail advertising according to claim 1, wherein said television advertising includes a component that directs the viewer to said direct mailer for specific contest rules.

11. A method for a sponsoring broadcaster to provide integrated television and direct mail advertising to an advertiser using a value-added pricing approach, comprising the steps of:
marketing integrated television and direct mail advertising to advertisers;
pricing integrated television and direct mail advertising using traditional broadcast media pricing for air time;
providing the direct mail component as a value-added service at no perceived extra cost;
providing television advertising for said advertiser at a price comparable to direct mail, and framing said television advertising with a cross-reference message to look for a forthcoming direct mailer;
distributing a direct mailer for said advertiser to a local viewing area at no perceived cost to the advertiser, said direct mailer including cross-referencing to said television advertising;
whereby said television advertising is integrated with said direct mail advertising by said broadcaster.

12. A method of selling advertising to small business owners who traditionally purchase a budgeted amount of direct mail advertising to entice them to try television advertising, comprising the steps of:
establishing a pricing schedule for television broadcast airtime inclusive of airing channel, airing times, and ad run frequency;
adjusting said pricing schedule to appear as established direct mail campaign price schedule including cost per capita exposure;
marketing said television broadcast airtime to said small business owner using said adjusted pricing schedule at a suggested total cost commensurate with the budgeted amount of direct mail advertising traditionally purchased by said small business owner;
providing an incentive to said small business owner to purchase the television broadcast airtime at said suggested total cost by offering to include direct mail advertising as a value added service at no perceived additional cost to eliminate perceived risk of losing an established direct mail client base;
producing a broadcast advertising component that includes a cross-reference to a direct mail advertising campaign;
publishing a direct mail advertising campaign that includes a cross-reference to said broadcast advertising campaign;
whereby said small business owner is encouraged to transition from direct mail advertising to television advertising.

13. The method of claim 12, wherein said broadcast advertising component contains a primary message to consumers.

14. The method of claim 13, wherein said direct mail advertising campaign contains a secondary message to consumers that explains that the primary message is to be given by broadcast advertising.

15. The method of claim 14, wherein said broadcast advertising comprises television broadcast advertising.

16. The method of claim 13, wherein said step of publishing a direct mail advertising campaign further comprises sending a direct mailer to consumers having ZIP codes inside the broadcast television viewing area to provide reinforced cross-referenced advertising to a core subset of consumers.
